(19) United States
(12) Patent Application Publication
(10) Pub. No.: US 2019/0014754 A1
(43) Pub. Date: Jan. 17, 2019

(54) DENITRIFYING DEVICE AND AQUATIC ORGANISM BREEDING SYSTEM

(71) Applicant: NATIONAL UNIVERSITY CORP. TOKYO UNIVERSITY OF MARINESCIENCE AND TECHNOLOGY, Tokyo (JP)

(72) Inventors: Makoto ENDO, Tokyo (JP); Takeshi TERAHARA, Tokyo (JP)

(73) Assignee: NATIONAL UNIVERSITY CORP. TOKYO UNIVERSITY OF MARINE SCIENCE AND TECHNOLOGY, Tokyo (JP)

(21) Appl. No.: 16/064,944

(22) PCT Filed: Nov. 11, 2016
(86) PCT No.: PCT/JP2016/083548

§ 371 Date: Jun. 21, 2018

(30) Foreign Application Priority Data
Dec. 22, 2015 (JP) 2015-250196

(51) Int. Cl. A01K 63/04; C02F 3/06; C02F 3/10; C02F 3/34; C02F 3/30

(52) U.S. Cl. CPC A01K 63/045; C02F 3/06; C02F 2101/163; C02F 3/34; C02F 3/302; C02F 3/10

(57) ABSTRACT

A denitrifying device and an aquatic organism breeding system are provided which are capable of efficiently denitrifying breeding water for an aquatic organism under an aerobic condition. A denitrifying device 20 according to an embodiment is a denitrifying device 20 for breeding water used for breeding an aquatic organism, including: a filtering tank 21 into which the breeding water stored in a breeding water tank 2 is supplied by a pump 3; a filtering medium 22 housed in the filtering tank 21, and on which denitrifying bacteria that reduce nitrate nitrogen in the breeding water are fixed; and an intermittent water discharging unit 23 that intermittently performs an oxygen taking operation of discharging the breeding water stored in the filtering tank 21 into the breeding water tank 2 to expose the filtering medium 22.

### TECHNICAL FIELD

The present invention relates to a denitrifying device and an aquatic organism breeding system, and more particularly to a denitrifying device that efficiently denitrifies breeding water under an aerobic condition for breeding an aquatic organism, and an aquatic organism breeding system including the denitrifying device, and a nitrating device that nitrates breeding water.

### BACKGROUND ART

In breeding an aquatic organism, ammonia nitrogen (NH₄—N) is emitted by metabolism of the aquatic organism bred. Since ammonia has high toxicity to the aquatic organism, removing ammonia is a key point in healthily breeding the aquatic organism. In nature, ammonia nitrogen is turned into nitrogen gas by natural denitrification and released into the atmosphere. Specifically, the ammonia nitrogen is oxidized by nitrating bacteria and turned into nitrite nitrogen (NO₂—N) and further to nitrate nitrogen (NO₃—N). Then, the nitrite nitrogen and the nitrate nitrogen are reduced by denitrifying bacteria and turned into nitrogen gas (N₂), and released into the atmosphere.

However, in a closed circulatory system, it is difficult to create an environment for natural denitrification. Thus, conventionally, ammonia has been removed using a nitrating tank in which a nitrating reaction occurs under an aerobic condition and a denitrifying tank in which a denitrifying reaction occurs under an anaerobic condition (for example, see Patent Literature 1).

### CITATION LIST

### Patent Literature

Patent Literature 1: Japanese Patent Laid-Open No. 2006-136775

### SUMMARY OF INVENTION

### Technical Problem

The denitrifying reaction is a reaction in which nitrate nitrogen or nitrite nitrogen is reduced to nitrogen gas by action of denitrifying bacteria, and is generally said to occur in an anaerobic state. On the other hand, a breeding water tank in which an aquatic organism is bred requires an aerobic condition. Thus, to remove nitric acid, an anaerobic denitrifying tank needs to be provided separately from an aerobic breeding water tank and nitrating tank. However, in view of labor, cost, and risks (such as a risk of generation of hydrogen sulfide), it is very difficult to simultaneously operate the anaerobic denitrifying tank and the aerobic breeding water tank and nitrating tank for a long period, and the anaerobic denitrifying tank is not widely used.

If no denitrifying tank is provided, nitric acid accumulates in the breeding water tank. The nitric acid accumulated reduces the pH of breeding water and has a weak but chronic toxicity to organisms. Thus, when no denitrifying tank is provided, the breeding water needs to be frequently changed, which increases the cost of breeding aquatic organisms.

The present invention is achieved based on the technical recognition described above, and has an object to provide a denitrifying device and an aquatic organism breeding system which are capable of efficiently denitrifying breeding water for an aquatic organism under an aerobic condition.

### Solution to Problem

A denitrifying device according to the present invention is a denitrifying device for breeding water used for breeding an aquatic organism, including: a filtering tank into which the breeding water stored in a breeding water tank is supplied; a filtering medium housed in the filtering tank, and on which denitrifying bacteria that reduce nitrate nitrogen in the breeding water are fixed; and an intermittent water discharging unit that intermittently performs an oxygen taking operation of discharging the breeding water stored in the filtering tank into the breeding water tank to expose the filtering medium.

The denitrifying device may further include a different filtering medium housed in the filtering tank, and on which nitrating bacteria that oxidize ammonia nitrogen in the breeding water supplied into the filtering tank are fixed.

In the denitrifying device, the filtering medium and the different filtering medium may be arranged one above the other in the filtering tank.

In the denitrifying device, the filtering medium and the different filtering medium may be housed in different mesh bags.

In the denitrifying device, the intermittent water discharging unit may be constituted by a siphon that moves the breeding water in the filtering tank into the breeding water tank.

In the denitrifying device, the filtering tank and the intermittent water discharging unit may be made of resin.

In the denitrifying device, the intermittent water discharging unit may include a pipe line unit having a flow path through which the breeding water in the filtering tank is discharged into the breeding water tank, and a valve that is provided in the pipe line unit and intermittently opens/closes the flow path in the pipe line unit.

In the denitrifying device, the filtering medium may include porous cellulose.

An aquatic organism breeding system according to the present invention is an aquatic organism breeding system that breeds an aquatic organism in a closed circulatory system, including: a breeding water tank that stores breeding water for breeding the aquatic organism; a nitrating device that includes a nitrating tank and a first filtering medium housed in the nitrating tank, and oxidizes ammonia nitrogen in the breeding water with nitrating bacteria fixed on the first filtering medium; a denitrifying device that includes a denitrifying tank, a second filtering medium housed in the denitrifying tank, and an intermittent water discharging unit that intermittently performs an oxygen taking operation of discharging the breeding water stored in the denitrifying tank into the breeding water tank to expose the second filtering medium, the denitrifying device reducing nitrate nitrogen in the breeding water with denitrifying bacteria fixed on the second filtering medium under an aerobic condition; and a pump that draws the breeding water stored in the breeding water tank and pours the breeding water into the nitrating tank and the denitrifying tank.

In the aquatic organism breeding system, the intermittent water discharging unit may be constituted by a siphon that moves the breeding water in the denitrifying tank into the breeding water tank.

In the aquatic organism breeding system, the denitrifying tank and the intermittent water discharging unit may be made of resin.

In the aquatic organism breeding system, a volume of the second filtering medium may be larger than a volume of the first filtering medium.

In the aquatic organism breeding system, a ratio between the volume of the first filtering medium and the volume of the second filtering medium may be 1:3 to 1:5.

In the aquatic organism breeding system, the ratio between the volume of the first filtering medium and the volume of the second filtering medium may be 1:4.

In the aquatic organism breeding system, the nitrating device may further include a different intermittent water discharging unit that intermittently performs an oxygen taking operation of discharging the breeding water stored in the nitrating tank into the breeding water tank to expose the first filtering medium.

### Advantageous Effect of Invention

According to the present invention, a denitrifying device and an aquatic organism breeding system can be provided which are capable of efficiently denitrifying breeding water for an aquatic organism under an aerobic condition.

### BRIEF DESCRIPTION OF DRAWINGS

FIG. 1 shows a schematic configuration of an aquatic organism breeding system 1 according to a first embodiment of the present invention.

FIG. 2 is a graph showing changes with time in various nitrogen concentrations in breeding water when only a nitrating device 10 is operated (intermittent filtration).

FIG. 3 is a graph showing changes with time in nitrate nitrogen concentration in the breeding water when only a denitrifying device 20 is operated (intermittent filtration).

FIG. 4 is a graph showing changes with time in various nitrogen concentrations in the breeding water when the nitrating device 10 and the denitrifying device 20 are simultaneously operated (intermittent filtration).

FIG. 5 is a graph showing changes with time in various nitrogen concentrations in the breeding water when the nitrating device 10 and the denitrifying device 20 are simultaneously operated (intermittent filtration).

FIG. 6 shows a schematic configuration of an aquatic organism breeding system 1A according to a second embodiment of the present invention.

FIG. 7 is a graph showing changes with time in various nitrogen concentrations in breeding water for a pearl oyster.

FIG. 8 is a graph showing changes with time in various nitrogen concentrations in breeding water for a rock porgy.

FIG. 9 shows a schematic configuration of an aquatic organism breeding system 1B according to a third embodiment of the present invention.

### DESCRIPTION OF EMBODIMENTS

Now, embodiments of the present invention will be described with reference to the drawings.

### First Embodiment

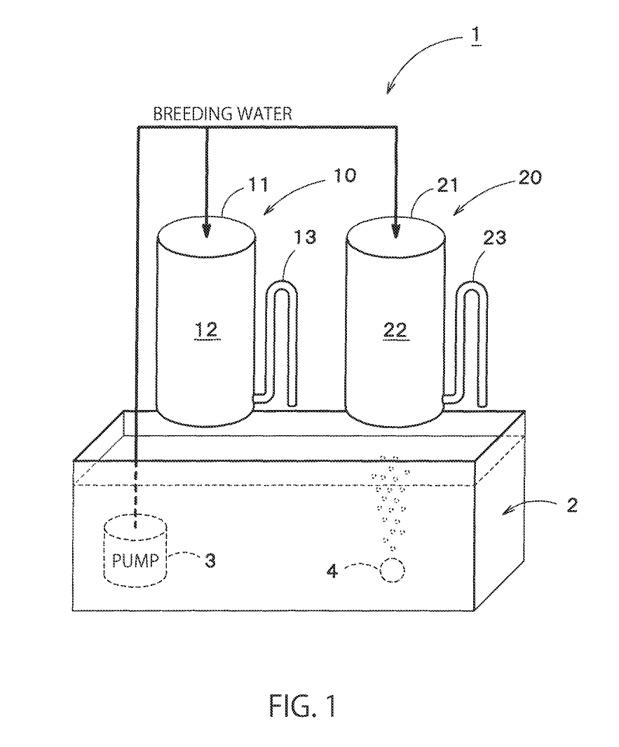

With reference to FIG. 1, an aquatic organism breeding system 1 according to a first embodiment will be described.

The aquatic organism breeding system 1 is an aquatic organism breeding system that breeds an aquatic organism in a closed circulatory system. The aquatic organism refers to an organism living in or near water, and includes, for example, fish, a shrimp, and a crab. The “water” herein refers to sea water or fresh water, and is not limited to one of them.

As shown in FIG. 1, the aquatic organism breeding system 1 includes a breeding water tank 2, a pump 3, an aeration 4, a nitrating device 10, and a denitrifying device 20.

The breeding water tank 2 is a water tank in which the aquatic organism is bred, and stores breeding water for breeding the aquatic organism. The pump 3 draws the breeding water stored in the breeding water tank 2, and continuously pours the breeding water into a nitrating tank 11 and a denitrifying tank 21 described later. The pump 3 is, for example, a submersible pump arranged in the breeding water tank 2 as shown in FIG. 1. The aeration 4 supplies air to the breeding water stored in the breeding water tank 2. The breeding water may be poured into the denitrifying tank 21 intermittently, not limited to continuously.

The nitrating device 10 includes the nitrating tank 11 arranged above the breeding water tank 2, a filtering medium 12 housed in the nitrating tank 11, and an intermittent water discharging unit 13. The nitrating device 10 oxidizes ammonia nitrogen and nitrite nitrogen in the breeding water supplied into the nitrating tank 11 with nitrating bacteria fixed on the filtering medium 12. The filtering medium 12 is, for example, a rectangular ceramic filtering medium or a porous ceramic cube. The filtering medium 12 is also referred to as a nitrating reaction substrate or simply a nitrating substrate.

The intermittent water discharging unit 13 intermittently performs an oxygen taking operation of discharging the breeding water stored in the nitrating tank 11 into the breeding water tank 2 to expose the filtering medium 12. The intermittent water discharging unit 13 is constituted by, for example, a siphon like an intermittent water discharging unit 23 of the denitrifying device 20 described later. The intermittent water discharging unit 13 of the nitrating device 10 is not an essential component. However, since the intermittent water discharging unit 13 intermittently exposes the filtering medium 12 to air, a high concentration of oxygen can be supplied to the nitrating bacteria, thereby facilitating a nitrating reaction that occurs under an aerobic condition.

The denitrifying device 20 includes the denitrifying tank (filtering tank) 21 arranged above the breeding water tank 2, a filtering medium 22 housed in the denitrifying tank 21, and the intermittent water discharging unit 23 provided in the denitrifying tank 21. The denitrifying device 20 reduces nitrate nitrogen and nitrite nitrogen in the breeding water supplied into the denitrifying tank 21 with denitrifying bacteria fixed on the filtering medium 22 under the aerobic condition. The filtering medium 22 is also referred to as a denitrifying reaction substrate or simply a denitrifying substrate. A type of denitrifying bacteria is not particularly limited, but may be a general one. Bacteria fixed on porous cellulose as the filtering medium 22 were separated. A plurality of bacteria were separated, and separated identification of dominant species (identification of species by 16S ribosomal RNA gene sequence) was performed. Then, it was found that the dominant species was Thalassospira sp., conventionally said to cause a denitrifying reaction under an anaerobic condition.

The filtering medium 22 preferably includes porous cellulose, for example, granular, block-like, or layered porous cellulose. The denitrifying bacteria feed on cellulose, and thus the number of denitrifying bacteria increases to improve a denitrifying capability.

The intermittent water discharging unit 23 intermittently performs an oxygen taking operation of discharging the breeding water stored in the denitrifying tank 21 into the breeding water tank 2 to expose the filtering medium 22. The intermittent water discharging unit 23 intermittently discharges the breeding water in the denitrifying tank 21 to intermittently expose the filtering medium 22 to air. After exposed to air, the filtering medium 22 is again submerged in the breeding water poured from the pump 3. As such, the filtering medium 22 is intermittently exposed to air, thereby allowing a high concentration of oxygen to be supplied to the denitrifying bacteria. This can facilitate a denitrifying reaction by the denitrifying bacteria under an aerobic condition and efficiently denitrify the breeding water as described later in detail with experimental results.

As shown in FIG. 1, the intermittent water discharging unit 23 is constituted by a siphon and moves the breeding water at high level in the denitrifying tank 21 into the breeding water tank 2 containing the breeding water at low level by the principle of the siphon. Specifically, when a predetermined amount of breeding water is stored in the denitrifying tank 21, the breeding water is automatically discharged.

The intermittent water discharging unit 23 is constituted by the siphon, thereby eliminating the need to provide a control unit for operation power or a valve. This allows the intermittent water discharging unit 23 to have an inexpensive and simple configuration. Further, the breeding water in the denitrifying tank 21 is discharged swiftly at once by the siphon. Thus, even if the pump 3 continuously pours the water into the denitrifying tank 21 for a long period, substances suspended in the water such as remaining food or droppings of the aquatic organism are prevented from clogging an opening in the filtering medium 22. As a result, the denitrifying tank 21 can be always kept in an aerobic environment, and the frequency of maintenance such as cleaning of the denitrifying tank 21 can be reduced.

The denitrifying tank 21 and the intermittent water discharging unit 23 are preferably entirely made of resin without containing a metal part. This can improve salt resistance and can prevent rust or corrosion of the denitrifying device 20 even if sea water is used as the breeding water. The nitrating tank 11 and the intermittent water discharging unit 13 are preferably entirely made of resin without containing a metal part.

The aquatic organism breeding system 1 may include a protein skimmer/foam separator (not shown). The protein skimmer is originally a device that removes organic substances or microorganisms in sea water with nanobubbles, but may be used for keeping a large amount of dissolved oxygen in the breeding water.

As described above, according to this embodiment, the filtering medium 22 is intermittently exposed to air to supply a high concentration of oxygen to the denitrifying bacteria, thereby facilitating a denitrifying reaction that occurs under an aerobic condition and efficiently denitrifying the breeding water for the aquatic organism. This can reduce cost of the aquatic organism breeding system and improve maintainability and safety as compared to a case of providing a conventional anaerobic denitrifying tank.

Next, examples using the aquatic organism breeding system 1 will be described.

### Example 1

As the nitrating tank 11 and the denitrifying tank 21, pipette washers (manufactured by IKEDA SCIENTIFIC Co., Ltd., capacity of 10 liters) were used. As the filtering medium (nitrating substrate) 12, a rectangular ceramic filtering medium was used, and as the filtering medium (denitrifying substrate) 22, porous cellulose particles (manufactured by Rengo Co., Ltd, Viscopearl A(R), diameter of 3 mm) were used. The filtering medium 12 and the filtering medium 22 were housed in nylon mesh bags and loaded into the nitrating tank 11 and the denitrifying tank 21, respectively.

The breeding water tank 2 used had a capacity of 200 liters. The breeding water tank 2 was filled with 150 liters of artificial sea water (manufactured by Nihonkaisui Co., Ltd.). During an experiment, the aeration 4 sufficiently aerated breeding water. Thus, the breeding water in all of the breeding water tank 2, the nitrating tank 11, and the denitrifying tank 21 was kept at a water temperature of 22±1° C., a salt content of 3.0 to 3.2%, pH of 8.4 to 8.6, and DO (amount of dissolved oxygen) of 6 to 8 ppm. Since cellulose used in the filtering medium 22 was decomposed to supply carbon, methanol or the like as a carbon source required for a denitrifying reaction was not added.

The pump 3 was used to continuously supply the sea water in the breeding water tank 2 into the nitrating tank 11 and the denitrifying tank 21. An amount of water supplied was liters/minute for both the nitrating tank 11 and the denitrifying tank 21. Intermittent filtration (oxygen taking operation) was performed about once per two minutes (about 720 times/day) for both the nitrating tank 11 and the denitrifying tank 21.

The breeding water was regularly drawn, and an ammonia nitrogen concentration (NH₄—N), a nitrite nitrogen concentration (NO₂—N), and a nitrate nitrogen concentration (NO₃—N) contained in the breeding water were measured. Here, a reagent set for water quality measurement (manufactured by KYORITSU CHEMICAL-CHECK Lab., Corp., LR-NH3, LR-HNO2, LR-HNO3) was used. If accurate values were required, the concentrations were measured using a spectrophotometer according to a manual attached to the set.

Next, Experiments 1 to 4 performed will be described.

### Experiment 1: Nitrating Capability of Nitrating Device

In this experiment, to determine a nitrating capability of the nitrating device 10, only the nitrating device 10 was operated (that is, without the denitrifying device 20 being operated) to measure a nitrogen concentration in the breeding water.

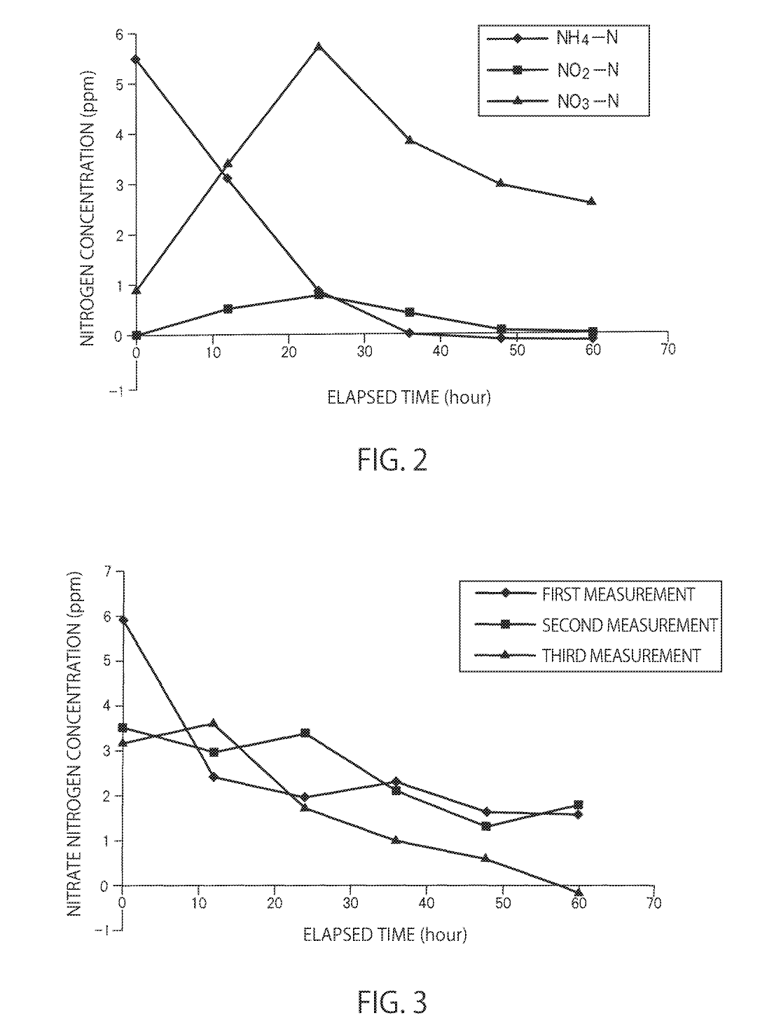

First, ammonium chloride was added to the breeding water in the breeding water tank 2 to set an ammonia concentration in the breeding water to a predetermined value. Then, the pump 3 was used to pour the breeding water into only the nitrating tank 11, and the breeding water was drawn every hours. An ammonia nitrogen concentration, a nitrite nitrogen concentration, and a nitrate nitrogen concentration in the drawn breeding water were measured. Measuring results are shown in FIG. 2.

As shown in FIG. 2, the ammonia nitrogen concentration rapidly decreased with time, and was no longer detected after 36 hours. With decreasing ammonia nitrogen concentration, the nitrite nitrogen concentration and the nitrate nitrogen concentration increased. Thus, it was confirmed that the nitrating device 10 performed a nitrating action.

### Experiment 2: Denitrifying Capability of Denitrifying Device

In this experiment, to determine a denitrifying capability of the denitrifying device 20, only the denitrifying device 20 was operated (that is, without the nitrating device 10 being operated) to measure a nitrogen concentration in the breeding water.

First, potassium nitrate was added to the breeding water in the breeding water tank 2 to set a nitric acid concentration in the breeding water to a predetermined value. Then, the pump 3 was used to pour the breeding water into only the denitrifying tank 21, and the breeding water was drawn every 12 hours. A nitrate nitrogen concentration in the drawn breeding water was measured. Measuring results are shown in FIG. 3. In FIG. 3, for “first” and “second” measurements, an amount of dissolved oxygen was set to 6 ppm, and for a “third” measurement, a protein skimmer was operated to set the amount of dissolved oxygen to 8 ppm.

Then, the pump 3 was used to pour the breeding water into only the denitrifying tank 21, and the breeding water was drawn every 12 hours. A nitrate nitrogen concentration in the drawn breeding water was measured. Measuring results are shown in FIG. 3. As shown in FIG. 3, the nitrate nitrogen concentration decreased with time for all concentration settings. In particular, when the amount of dissolved oxygen was set to 6 ppm, nitrate nitrogen significantly decreased. This shows that a larger amount of dissolved oxygen facilitates a denitrifying reaction.

### Experiment 3: Nitrating Capability and Denitrifying Capability for Intermittent Filtration

In this experiment, to determine a nitrating capability and a denitrifying capability for intermittent filtration, both the nitrating device 10 and the denitrifying device 20 were operated to measure various nitrogen concentrations in the breeding water.

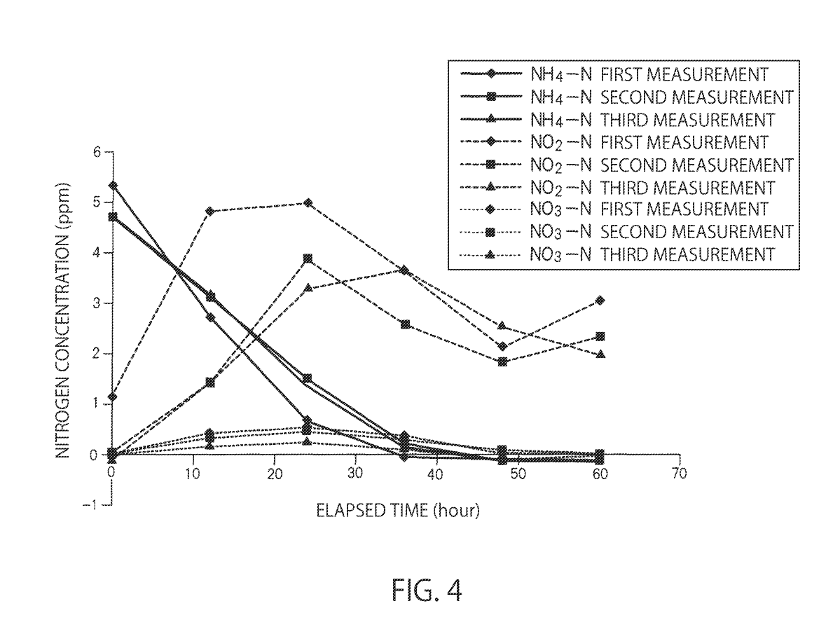

First, ammonium chloride was added to the breeding water in the breeding water tank 2 to set an ammonia concentration in the breeding water to a predetermined value. Then, the pump 3 was used to pour the breeding water into both the nitrating tank 11 and the denitrifying tank 21, and the breeding water was drawn every 12 hours. An ammonia nitrogen concentration, a nitrite nitrogen concentration, and a nitrate nitrogen concentration in the drawn breeding water were measured. Measuring results are shown in FIG. 4. In FIG. 4, for “first” and “second” measurements, an amount of dissolved oxygen was set to 6 ppm, and for a “third” measurement, a protein skimmer was operated to set the amount of dissolved oxygen to 8 ppm.

In view of an influence of chronic toxicity of nitric acid on an aquatic organism, acceptable values of a nitrate nitrogen concentration and a nitrite nitrogen concentration are about 2 ppm even for species with particularly high sensitivity (Camargo et al., 2005). Aerobic denitrification by the intermittent filtration achieved the concentrations close to the acceptable values.

From measuring data of this experiment, an ammonia removing capability of the aquatic organism breeding system 1 is substantially equal to that of a conventional anaerobic denitrifying tank with sulfur calcium (DO of about 2 ppm, 20 mg N/L/day). This may be for the following reason. Conventional anaerobic denitrification requires a reduction in oxygen amount in a denitrifying tank. Thus, a small pouring amount of breeding water has to be kept. On the other hand, the aerobic denitrification using the denitrifying device 20 does not have such a limit, and can increase a pouring amount of breeding water. Thus, the denitrifying device 20 can increase the frequency of filtration, although having a lower denitrifying capability per capacity as compared to the anaerobic denitrifying tank, thereby achieving a total denitrifying amount (denitrifying capability per capacity×frequency of filtration) equal to that of the anaerobic denitrifying tank.

It is found from the experimental result that the denitrifying reaction proceeds more slowly than the nitrating reaction. Thus, it is considered that a continuous large ammonia load increases accumulation of nitric acid. Therefore, a volume of the filtering medium (denitrifying substrate) 22 is preferably larger than a volume of the filtering medium (nitrating substrate) 12. More specifically, from a comparison between a decreasing speed of the ammonia nitrogen concentration by the nitrating reaction and a decreasing speed of the nitrate nitrogen concentration and the nitrite nitrogen concentration by the denitrifying reaction, a ratio between the volume of the filtering medium 12 and the volume of the filtering medium 22 is preferably 1:3 to 1:5, and more preferably 1:4. This achieves a proper balance between the reaction speed of the nitrating reaction and the reaction speed of the denitrifying reaction.

### Experiment 4: Nitrating Capability and Denitrifying Capability for Normal Filtration

In this experiment, as a comparison with Experiment 3 (intermittent filtration), an ammonia nitrogen concentration, a nitrite nitrogen concentration, and a nitrate nitrogen concentration for normal filtration were measured. In this experiment, the following two aquatic organism breeding systems were configured.

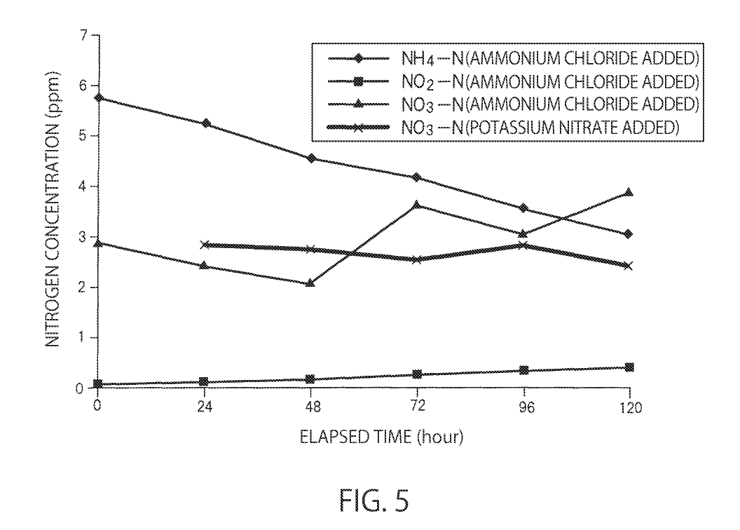

In the first system, the siphon (intermittent water discharging unit 23) was removed from the denitrifying tank 21. Potassium nitrate was added to the breeding water in the breeding water tank 2 to set a nitric acid concentration in the breeding water to a predetermined value. Then, the pump 3 was used to pour the breeding water into the denitrifying tank 21 (3 liters/minutes), and the breeding water was drawn every 24 hours. A measuring result is shown in FIG. 5 (NO₃—N (potassium nitrate added)). As shown in FIG. 5, the nitrate nitrogen concentration only slightly decreased. This result and the result of Experiment 3 show that the intermittent filtration is effective for facilitating the denitrifying reaction.

In the second system, the siphons (intermittent water discharging units 13, 23) were removed from the nitrating tank 11 and the denitrifying tank 21. Also, a ratio between the volume of the filtering medium 12 and the volume of the filtering medium 22 was adjusted to 1:4, and the filtering medium 12 and the filtering medium 22 were loaded into the nitrating tank 11 and the denitrifying tank 21, respectively. Ammonium chloride was added to the breeding water in the breeding water tank 2 to set an ammonia concentration in the breeding water to a predetermined value.

The pump 3 was used to pour the breeding water into the nitrating tank 11 and the denitrifying tank 21, and the breeding water was drawn every 24 hours. An ammonia nitrogen concentration, a nitrite nitrogen concentration, and a nitrate nitrogen concentration in the drawn breeding water were measured. Measuring results are shown in FIG. 5. As shown in FIG. 5, the ammonia nitrogen concentration decreased, while the nitrite nitrogen concentration and the nitrate nitrogen concentration increased.

From the experimental results of the above two normal filtration systems, it is inferred that for the normal filtration, the denitrifying reaction does not sufficiently occur due to a small amount of oxygen supplied into the denitrifying tank 21. It was found that for the normal filtration, the denitrifying reaction might occur, but a capability thereof was extremely low.

On the other hand, the intermittent filtration has a time when the filtering medium (denitrifying substrate) 22 is completely exposed to air, and thus a high concentration of oxygen is supplied to the denitrifying substrate. This can keep the entire denitrifying tank 21 aerobic, thereby increasing the denitrifying capability.

Also, since the denitrifying reaction proceeds under the aerobic condition, a time before the denitrifying reaction occurs can be significantly reduced as compared to the conventional anaerobic denitrifying reaction. For example, at a water temperature of 22° C., the denitrifying reaction starts to occur in about 3 to 4 days.

### Second Embodiment

Next, an aquatic organism breeding system 1A according to a second embodiment will be described. One of differences between the second embodiment and the first embodiment is that the nitrating device and the denitrifying device are integrated. As described in the first embodiment, in the aquatic organism breeding system according to the present invention, the nitrating reaction and also the denitrifying reaction proceed in an aerobic environment, thereby allowing the nitrating device and the nitrating device to be integrated.

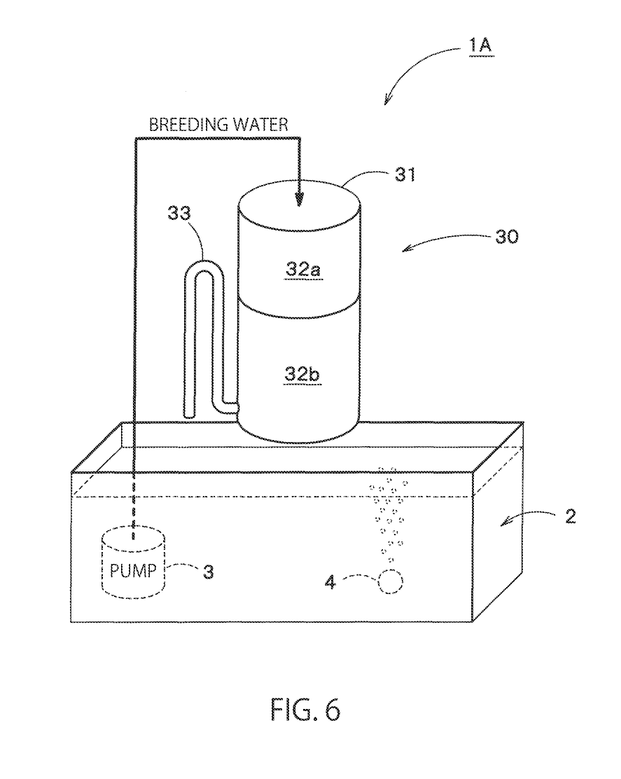

FIG. 6 shows a schematic configuration of the aquatic organism breeding system 1A according to the second embodiment. In FIG. 6, the same components as in FIG. 1 described in the first embodiment are denoted by the same reference numerals.

As shown in FIG. 6, the aquatic organism breeding system 1A includes a breeding water tank 2, a pump 3, an aeration 4, and a filtering device 30. The breeding water tank 2, the pump 3, and the aeration 4 are the same as those in the first embodiment, and descriptions thereof will be omitted.

The filtering device 30 includes a filtering tank 31 arranged above the breeding water tank 2, a filtering medium (nitrating substrate) 32a and a filtering medium (denitrifying substrate) 32b housed in the filtering tank 31, and an intermittent water discharging unit 33. The filtering device 30 oxidizes ammonia nitrogen and nitrite nitrogen in breeding water supplied into the filtering tank 31 by the pump 3 with nitrating bacteria fixed on the filtering medium 32a. Further, the filtering device 30 reduces nitrate nitrogen and nitrite nitrogen in the breeding water with denitrifying bacteria fixed on the filtering medium 32b under an aerobic condition.

Like the filtering medium 12 described in the first embodiment, the filtering medium 32a is, for example, a rectangular ceramic filtering medium or a porous ceramic cube. Like the filtering medium 22 described in the first embodiment, the filtering medium 32b is, for example, granular, block-like, or layered porous cellulose.

The filtering medium 32a and the filtering medium 32b are arranged one above the other in the filtering tank 31. For example, first, the filtering tank 31 is filled with porous cellulose particles by a predetermined volume, and then filled with porous ceramic cubes by a predetermined volume. The filling order may be reversed. The filtering medium 32a and the filtering medium 32b may be arranged side by side rather than one above the other in the filtering tank 31. Also, the filtering medium 32a and the filtering medium 32b may be housed in mesh bags. For example, the porous cellulose particles may be housed in a first mesh bag, the porous ceramic cubes may be housed in a second mesh bag, and the first and second mesh bags housing the filtering media may be loaded into the filtering tank 31. Further, the filtering medium 32a and the filtering medium 32b may be separated by a partitioning member in the filtering tank 31, or may be mixed in the filtering tank 31 without being separated.

The intermittent water discharging unit 33 intermittently performs an oxygen taking operation of discharging the breeding water poured from the breeding water tank 2 into the filtering tank 31 and stored in the filtering tank 31 into the breeding water tank 2 to expose the filtering medium 32a and the filtering medium 32b. As shown in FIG. 6, the intermittent water discharging unit 33 is constituted by a siphon, and when a predetermined amount of breeding water is stored in the filtering tank 31, the breeding water is automatically discharged. The intermittent water discharging unit 33 intermittently discharges the breeding water in the filtering tank 31 to intermittently expose the filtering medium 32a and the filtering medium 32b to air. This allows a high concentration of oxygen to be supplied to the nitrating bacteria and the denitrifying bacteria, thereby obtaining the same advantage as in the first embodiment.

Further, in the second embodiment, the nitrating device and the denitrifying device are integrated in one filtering device, thereby reducing cost and size of the aquatic organism breeding system.

Next, Examples 2 and 3 using the aquatic organism breeding system 1A will be described.

### Example 2

As the filtering tank 31, a pipette washer (manufactured by IKEDA SCIENTIFIC Co., Ltd., capacity of 10 liters) was used. As the filtering medium (nitrating substrate) 32a, a rectangular ceramic filtering medium was used, and as the filtering medium (denitrifying substrate) 32b, porous cellulose particles (manufactured by Rengo Co., Ltd, Viscopearl A(R), diameter of 3 mm) were used. The filtering medium 32a and the filtering medium 32b were housed in nylon mesh bags, and loaded into the filtering tank 31.

The breeding water tank 2 used had a capacity of 200 liters. The breeding water tank 2 was filled with 150 liters of artificial sea water (manufactured by Nihonkaisui Co., Ltd.).

During an experiment, the aeration 4 sufficiently aerated breeding water. Also, a protein skimmer (manufactured by Plesca Co., Ltd., Model FS-002P) was operated to keep a large amount of dissolved oxygen in the breeding water. Thus, water quality of the breeding water in the breeding water tank 2 was kept at a water temperature of 22° C., a salt content of 3%, pH of 8.6, and DO of 8 ppm. Since cellulose used in the filtering medium 32b was decomposed to supply carbon, methanol or the like as a carbon source required for a denitrifying reaction was not added.

The pump 3 was used to supply the sea water in the breeding water tank 2 into the filtering tank 31. An amount of water supplied was 3 liters/minute. Intermittent filtration was performed about once per two minutes.

Next, Experiment 5 performed will be described.

### Experiment 5: Ammonia Removing Capability in Breeding of Aquatic Organism

In this experiment, to determine an ammonia removing capability of the aquatic organism breeding system 1A in breeding an aquatic organism, the filtering device 30 was operated to measure a nitrogen concentration in the breeding water. A ratio between the volume of the filtering medium 32a and the volume of the filtering medium 32b was adjusted to 1:4, and the filtering medium 32a and the filtering medium 32b were loaded into the filtering tank 31.

Two aquatic organism breeding systems 1A were prepared. In one system, nine pearl oysters (unshelled wet weight of about 80 g) were bred, and in the other system, one rock porgy (weight of about 400 g) was bred. Both the pearl oysters and the rock porgy were bred without feeding.

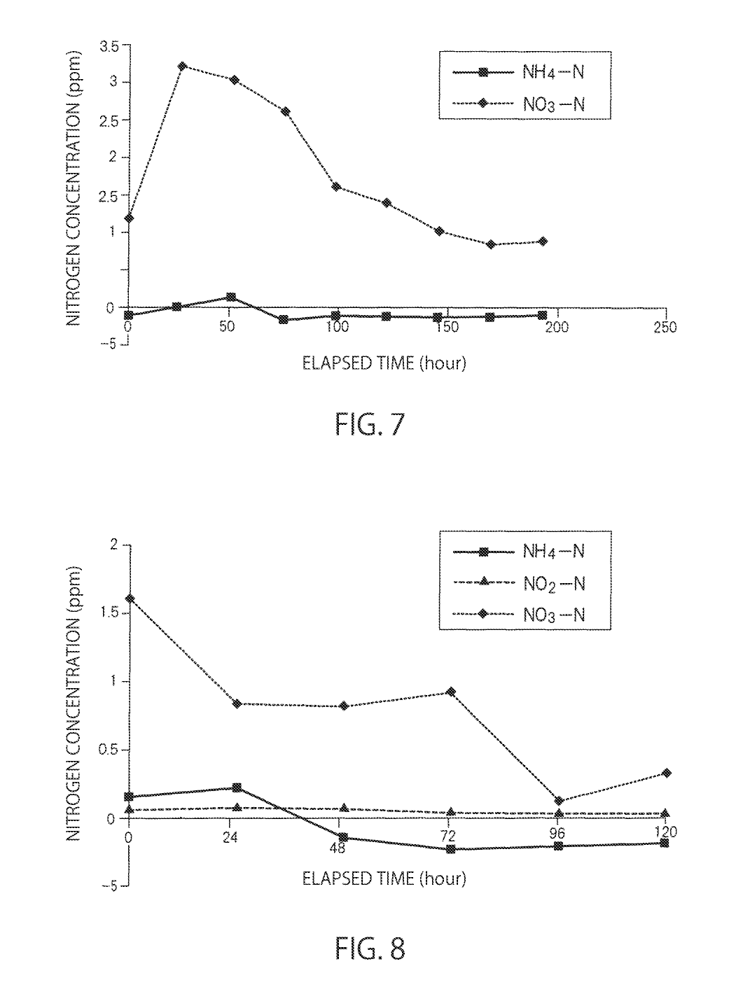

For the pearl oysters, the filtering tank 31 was not operated for one day from the beginning of the breeding, and the filtering tank 31 and a protein skimmer were operated from the second day when an increase in ammonia concentration was confirmed. The pump 3 was used to pour the breeding water into the filtering tank 31, and the breeding water was drawn every 24 hours. An ammonia nitrogen concentration and a nitrate nitrogen concentration in the breeding water were measured. Measuring results are shown in FIG. 7. As shown in FIG. 7, the nitrate nitrogen concentration and the ammonia nitrogen concentration increased at the beginning of the breeding and then decreased. The nitrate nitrogen concentration decreased to about 1 ppm.

For the rock porgy, the filtering tank 31 and the protein skimmer were operated from the beginning of the breeding. The pump 3 was used to pour the breeding water into the filtering tank 31, and the breeding water was drawn every 24 hours. An ammonia nitrogen concentration, a nitrite nitrogen concentration, and a nitrate nitrogen concentration in the breeding water were measured. Measuring results are shown in FIG. 8. As shown in FIG. 8, the nitrate nitrogen concentration, the nitrite nitrogen concentration, and the ammonia nitrogen concentration were all kept at low values from the beginning of the breeding.

### Example 3

As the filtering device 30, a rectangular water tank (capacity of 45 liters) was used. As the filtering medium (nitrating substrate) 32a, a rectangular ceramic filtering medium was used, and as the filtering medium (denitrifying substrate) 32b, porous cellulose particles (manufactured by Rengo Co., Ltd, Viscopearl A(R), diameter of 3 mm) were used. The filtering medium 32a (3 liters) and the filtering medium 32b (10 liters) were housed in different nylon mesh bags, and the two mesh bags were loaded into the filtering tank 31.

The breeding water tank 2 used had a capacity of 200 liters. The breeding water tank 2 was filled with 150 liters of fresh water. The pump 3 was used to supply the fresh water in the breeding water tank 2 into the filtering tank 31. An amount of water supplied was 6 liters/minute. Intermittent filtration was performed about once per three minutes. The pH and DO of the breeding water were 7.6 and 7 ppm, respectively.

Next, Experiment 6 performed will be described.

### Experiment 6: Ammonia Removing Capability in Breeding Aquatic Organism

In this experiment, 50 goldfishes (a length of 3 to 5 cm, a total weight of 245 g) were bred for two months by feeding a proper amount of food a few times daily.

Since the volume of the filtering medium (denitrifying substrate) 32b decreased to half in about 1.5 months from the beginning of the breeding, 2 liters of denitrifying substrate was added. A water temperature of the breeding water was 22° C. for two months after the beginning of the breeding, and then decreased to 13° C. to 14° C. by changing all water. The breeding with feeding was continued for two weeks after the decrease in water temperature. Then, the water temperature of the breeding water was returned to 22° C.

For two months after the beginning of the breeding (at the water temperature of 22° C.), an ammonia nitrogen concentration of less than 2 ppm, a nitrite nitrogen concentration of less than 0.2 ppm, and a nitrate nitrogen concentration of less than 10 ppm were kept. For the breeding at the low water temperature (13° C. to 14° C.), the ammonia nitrogen concentration, the nitrite nitrogen concentration, and the nitrate nitrogen concentration temporarily increased to 5 ppm, 0.5 ppm, and 20 ppm, respectively, for 10 days after the decrease in water temperature. However, after that, the ammonia nitrogen concentration of less than 2 ppm, the nitrite nitrogen concentration of less than 0.1 ppm, and the nitrate nitrogen concentration of less than 10 ppm were kept.

After two weeks from the decrease in water temperature, the water temperature of the breeding water was again increased to 22° C. Then, the ammonia nitrogen concentration, the nitrite nitrogen concentration, and the nitrate nitrogen concentration decreased to 2 ppm, 0.1 ppm, and 2 ppm, respectively, and became stable.

As such, it was confirmed that even at the low water temperature, a nitrating reaction and a denitrifying reaction occur under an aerobic condition. At the low water temperature, an ammonia removing capability may at least temporarily decrease as compared to at the high water temperature. However, at the low water temperature, an amount of ammonia excretion of goldfishes also decreases, thereby allowing various nitrogen concentrations in the breeding water to be kept at low values.

### Third Embodiment

Next, an aquatic organism breeding system 1B according to a third embodiment will be described. One of differences between the third embodiment and the second embodiment is a configuration of the intermittent water discharging unit. The intermittent water discharging unit in this embodiment is constituted by a valve.

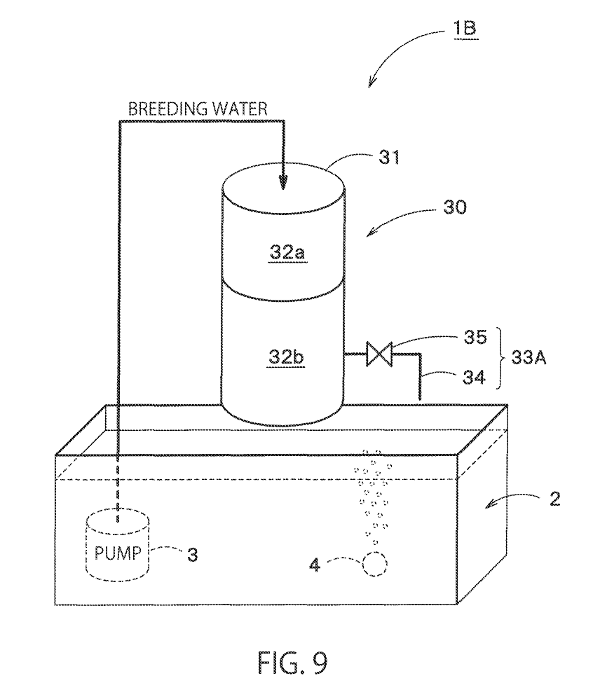

FIG. 9 shows a schematic configuration of the aquatic organism breeding system 1B according to the third embodiment. In FIG. 9, the same components as in FIG. 6 described in the second embodiment are denoted by the same reference numerals.

As shown in FIG. 9, the aquatic organism breeding system 1B includes a breeding water tank 2, a pump 3, an aeration 4, and a filtering device 30. The breeding water tank 2, the pump 3, and the aeration 4 are the same as those in the first and second embodiments, and descriptions thereof will be omitted.

The filtering device 30 includes a filtering tank 31 arranged above the breeding water tank 2, a filtering medium (nitrating substrate) 32a and a filtering medium (denitrifying substrate) 32b housed in the filtering tank 31, and an intermittent water discharging unit 33A.

The intermittent water discharging unit 33A includes a pipe line unit 34 and a valve 35. The pipe line unit 34 includes a flow path through which breeding water in the filtering tank 31 is discharged into the breeding water tank 2. The valve 35 is provided in the pipe line unit 34 and intermittently opens/closes the flow path in the pipe line unit 34. Thus, as in the second embodiment, the filtering device 30 can efficiently reduce nitrate nitrogen and nitrite nitrogen in the breeding water with denitrifying bacteria fixed on the filtering medium 32b under an aerobic condition.

The intermittent water discharging unit in the present invention may be a unit that intermittently performs an oxygen taking operation of discharging breeding water stored in a filtering tank into a breeding water tank to expose a filtering medium, and is not limited to the configurations of the intermittent water discharging units 23, 33, 33A and the pump 3 described above. As the oxygen taking operation, the filtering medium (denitrifying substrate) in the filtering tank may be submerged in the breeding water, and then an air pump may be used to feed air into the filtering tank to expose the filtering medium 22.

The three embodiments of the present invention have been described above. The denitrifying device according to the present invention may be applied to denitrification of breeding water involved in, for example, onshore fish farming, breeding of ornamental fish, transportation of fresh fish, or the like. The denitrifying device according to the present invention may be also applied to denitrification of untreated water other than breeding water used for breeding an aquatic organism, for example, untreated water such as livestock wastewater or agricultural wastewater.

Additional advantages or various modifications may be conceived by those skilled in the art based on the above descriptions, however, aspects of the present invention are not limited to the individual embodiments described above. The components in the different embodiments may be combined as appropriate. Various additions, changes, and partial deletions may be made without departing from the conceptual idea and gist of the present invention derived from the content defined in claims and equivalents thereof.

### REFERENCE SIGNS LIST

1, 1A, 1B aquatic organism breeding system
2 breeding water tank
3 pump
4 aeration
10 nitrating device
11 nitrating tank
12 filtering medium (nitrating substrate)
13 intermittent water discharging unit
20 denitrifying device
21 denitrifying tank
22 filtering medium (denitrifying substrate)
23 intermittent water discharging unit
30 filtering device
31 filtering tank
32a filtering medium (nitrating substrate)
32b filtering medium (denitrifying substrate)
33, 33A intermittent water discharging unit
34 pipe line unit
35 valve

1. A denitrifying device for breeding water used for breeding an aquatic organism, comprising:
a filtering tank into which the breeding water stored in a breeding water tank is supplied;
a filtering medium housed in the filtering tank, and on which denitrifying bacteria that reduce nitrate nitrogen in the breeding water are fixed; and
an intermittent water discharging unit that intermittently performs an oxygen taking operation of discharging the breeding water stored in the filtering tank into the breeding water tank to expose the filtering medium to air, thereby facilitating a denitrifying reaction by the denitrifying bacteria under an aerobic condition.

2. The denitrifying device according to claim 1, further comprising a different filtering medium housed in the filtering tank, and on which nitrating bacteria that oxidize ammonia nitrogen in the breeding water supplied into the filtering tank are fixed.

3. The denitrifying device according to claim 1, wherein the intermittent water discharging unit is constituted by a siphon that moves the breeding water in the filtering tank into the breeding water tank.

4. The denitrifying device according to claim 3, wherein the filtering tank and the intermittent water discharging unit are made of resin.

5. The denitrifying device according to claim 1, wherein the intermittent water discharging unit includes a pipe line unit having a flow path through which the breeding water in the filtering tank is discharged into the breeding water tank, and a valve that is provided in the pipe line unit and intermittently opens/closes the flow path in the pipe line unit.

6. The denitrifying device according to claim 1, wherein the filtering medium includes porous cellulose.

7. An aquatic organism breeding system that breeds an aquatic organism in a closed circulatory system, comprising:
a breeding water tank that stores breeding water for breeding the aquatic organism;
a nitrating device that includes a nitrating tank and a first filtering medium housed in the nitrating tank, and oxidizes ammonia nitrogen in the breeding water with nitrating bacteria fixed on the first filtering medium;
a denitrifying device that includes a denitrifying tank, a second filtering medium housed in the denitrifying tank, and an intermittent water discharging unit that intermittently performs an oxygen taking operation of discharging the breeding water stored in the denitrifying tank into the breeding water tank to expose the second filtering medium to air, the denitrifying device reducing nitrate nitrogen in the breeding water with denitrifying bacteria fixed on the second filtering medium under an aerobic condition; and
a pump that draws the breeding water stored in the breeding water tank and pours the breeding water into the nitrating tank and the denitrifying tank.

8. The aquatic organism breeding system according to claim 7, wherein the intermittent water discharging unit is constituted by a siphon that moves the breeding water in the denitrifying tank into the breeding water tank.

9. The aquatic organism breeding system according to claim 8, wherein the denitrifying tank and the intermittent water discharging unit are made of resin.

10. The aquatic organism breeding system according to claim 7, wherein a volume of the second filtering medium is larger than a volume of the first filtering medium.

11. The aquatic organism breeding system according to claim 7, wherein a ratio between the volume of the first filtering medium and the volume of the second filtering medium is 1:3 to 1:5.

12. The aquatic organism breeding system according to claim 7, wherein a ratio between the volume of the first filtering medium and the volume of the second filtering medium is 1:4.

13. The aquatic organism breeding system according to claim 7, wherein the nitrating device further includes a different intermittent water discharging unit that intermittently performs an oxygen taking operation of discharging the breeding water stored in the nitrating tank into the breeding water tank to expose the first filtering medium to air.

14. A denitrifying device comprising:
a filtering tank into which untreated water stored in a water tank is supplied;
a filtering medium housed in the filtering tank, and on which denitrifying bacteria that reduce nitrate nitrogen in the untreated water are fixed; and
an intermittent water discharging unit that intermittently performs an oxygen taking operation of discharging the untreated water stored in the filtering tank into the water tank to expose the filtering medium to air, thereby facilitating a denitrifying reaction by the denitrifying bacteria under an aerobic condition.
